(19) United States
(12) Patent Application Publication
(10) Pub. No.: US 2021/0289718 A1
(43) Pub. Date: Sep. 23, 2021

(54) APPARATUS AND METHOD FOR ENHANCING PLANT GROWTH

(71) Applicants: Xiaojiang Zhang, Edmonton (CA); Shen Yue, Edmonton (CA)

(72) Inventors: Xiaojiang Zhang, Edmonton (CA); Shen Yue, Edmonton (CA)

(21) Appl. No.: 16/823,774

(22) Filed: Mar. 19, 2020

(51) Int. Cl. A01G 9/24; A01G 9/20; C09D 5/33; C09D 5/32; C25D 11/02; C25D 11/34

(52) U.S. Cl. CPC A01G 9/249; A01G 9/20; C25D 11/34; C09D 5/32; C25D 11/022; C09D 5/004

(57) ABSTRACT

This invention relates to an apparatus and method for enhancing plant growth through use of light-reflecting panels which comprise reflective surfaces that are capable of reflecting specific light wavelengths.

### BACKGROUND OF THE INVENTION

This invention relates to an apparatus for enhancing plant growth through use of light-reflecting panels to reflect light to a plant with controlled wavelengths and angles, and a method of regulating and improving plant growth using such apparatus.

More specifically, this invention relates to a modular and scalable apparatus to mainly enhance agricultural and horticultural crop yield and accelerate growth of plants including vegetables, fruits, and flowers. The key elements of this apparatus comprise: a light-reflecting panel comprising at least one reflective surface, a coating and a substrate and being capable of reflecting specific wavelengths of light; a panel holder which hosts said panels and control their positions; and a growing media container which is utilized to host plant growing media and water/air/carbon dioxide flow devices. The light-reflecting panel of this apparatus, being capable of efficiently reflecting specific wavelengths of light to a plant, provides a reliable and flexible complementary light with controlled intensity and quality for growing plants.

Further, this invention relates to a method to regulate and improve plant growth. The key elements of this method comprise: providing a light-reflecting panel to control the overall light intensity received by a plant; providing a light-reflecting panel to control the overall light quality received by a plant; controlling the distribution of light intensity and quality by adjusting the angle of reflected light using a panel holder; and providing a flexible way of adjusting the intensity and quality of the reflected light by combining modular light-reflecting panels.

### SUMMARY OF THE INVENTION

Rapid human population growth and limited farming/growing resources such as land and water are the two main forces driving increases in agricultural and horticultural demands. To feed the increasing population with limited resources, it is important to find a sustainable way of growing food—consuming less water and energy, using less chemicals including fertilizers and pesticides, and utilizing sunlight or artificial light more efficiently to grow plants faster with a higher yield. It is therefore a principal object of the present invention to provide an apparatus and a method that can regulate and enhance photosynthesis for plant growth. Another object of the present invention is to provide an apparatus and a method that can use sunlight or artificial light more efficiently, allowing higher yield of the crop as well as reductions on time to crop maturity, overall energy/resource consumption, and pest activities.

This invention provides an apparatus to reflect sunlight or artificial light to a plant, comprising: a light-reflecting panel comprising reflective surfaces capable of selectively reflecting light, a coating and a substrate; a panel holder having slots, adaptors, and mechanisms for hosting said panels and adjusting their positions to reflect light to the plant at controlled angles; and a growing media container comprising slots, adapters, and mechanisms for hosting plant growing media and water/air/CO2 flow devices.

This invention provides an apparatus that is capable of increasing the total amount of light received by a plant. In a conventional way growing a plant without using reflected light, it can only receive light directly from the light source like the sun or an artificial light. However, when using the apparatus of this invention, light reflected by the reflective panel is added to the original light reaching the plant to increase the total amount of light received for photosynthesis. Directly affecting the light-dependent reactions and indirectly affecting the light-independent reactions in the plant growth process, light intensity is one of the key factors affecting the rate of photosynthesis. The rate of photosynthesis for a plant will increase as light intensity increases as long as other key factors including water, temperature, and concentration of carbon dioxide are adequately supplied. The apparatus of this invention comprising light-reflecting panels is capable of increasing the overall light intensity received by a plant by redirecting light from the light source that cannot directly reach the plant. Instantly allowing more light from the light source to reach the plant, this apparatus enhances plant growth by simply improving the overall light intensity received by the plant.

This invention provides an apparatus that is capable of improving light quality or spectral composition which refers to the composition of light as to wavelengths that are effective in photosynthesis. Using this apparatus, a plant receives both direct light from the light source and reflected light from the light-reflecting panels. To change the light quality used in the photosynthesis process, specified wavelengths selectively reflected by the light-reflecting panel are added to the overall light received by the plant. Photosynthetically active radiation (PAR) includes wavelengths from about 400 nm to 700 nm which are critical to the biochemical processes. These wavelengths' relative proportion in the available light to a plant is of great importance in determining light quality. For example, it is known that the blue and red wavelengths are more effective in photosynthesis than other wavelengths, and being mostly transmitted or reflected by the plant, green light is least effective. The apparatus of this invention comprising light-reflecting panels has the ability to selectively reflect specific wavelengths of light to the plant to regulate its growth process. In a preferred embodiment of this invention, light-reflecting panels comprising a layer of substrate and a layer of wavelength-selecting or light modifying coating are responsible for reflecting desired ranges of wavelengths to a plant. In a preferred embodiment of this invention, light-reflecting panels comprising a substrate material such as metal, plastic, silicon, glass, quartz, sapphire and ceramic, and a coating material such as metal, polymer, oxides, fluorides, nitrides, sulfides, ceramics and diamond-like-coating are responsible for reflecting desired ranges of wavelengths to a plant. In a preferred embodiment of this invention, light-reflecting panels comprising anodized titanium or niobium are responsible for reflecting desired ranges of wavelengths to a plant. In a preferred embodiment of this invention, light-reflecting panels comprising reflective plastics such as colored acrylic mirrors or Mylar reflective sheets are responsible for reflecting desired ranges of wavelengths to a plant.

This invention provides an apparatus that is capable of improving the distribution of light intensity and light quality to a plant by reflecting light to the plant from different angles. When using sunlight to grow a plant, the light intensity and light quality reaching the plant vary according to many factors including location of absorbing plant organs (leaves) within the canopy, topography, weather condition, date of the year, time of the day, season, and geographic location. Conventionally, light reaches a plant from the top and the upper surface of leaves receives light. Using the apparatus of this invention, reflected light can reach a plant from the bottom and the side. Both the upper and lower surfaces of the leaves receive the reflected light. In a preferred embodiment of this invention, the plant growth apparatus comprises a panel holder having slots, adaptors, and mechanisms for hosting light-reflecting panels and adjusting their positions is capable of reflecting light to the plant with controlled angles to improve the distribution of light.

This invention provides a simple and sustainable method of regulating and enhancing plant growth using natural or artificial light, comprising: increasing the overall amount of light reached to a plant without adding additional light; delivering controlled and optimized light quality for photosynthesis to a plant by selectively reflecting light wavelengths from the light source; efficiently distributing light to a plant by deploying light-reflecting panels with controlled positions and angles; and controlling the intensity and quality of the reflected light by using combinations of different modular light-reflecting panels.

### BRIEF DESCRIPTION OF THE DRAWINGS

The following drawings show preferred embodiments and are not intended to restrict or otherwise limit the scope of the present invention.

FIG. 1 is a perspective view of the light-reflecting panel of the present invention.

FIG. 2 shows a perspective view of the plant growth apparatus of this invention having 16 modular bottom light-reflecting panels, 2 side light-reflecting panels, 4 panel holders, and a growing media container.

FIG. 3 illustrates light reaching the plant from the side and bottom, reflected by the side light-reflecting panel and the bottom light-reflecting panel, respectively.

FIG. 4 illustrates how light is reflected when the light-reflecting panel works on the principle of thin-film interference.

FIG. 5 is a colored picture of the plant growth apparatus of this invention that can host 32 plants, comprising the same type of light-reflecting panels on the bottom and the side.

FIG. 6 is a colored picture of the plant growth apparatus of this invention that can host 32 plants, comprising different types of light-reflecting panels on the bottom and the side.

FIG. 7 is a colored picture of a larger plant growth apparatus of this invention that can host 1024 plants, comparing 32 smaller plant growth modules.

FIG. 8 is a photograph of light-reflecting panels made of anodized titanium according to an embodiment of this invention.

FIG. 9 is a photograph of light-reflecting panels made of anodized titanium according to an embodiment of this invention. Four different anodized titanium light-reflecting panels are shown in this photograph including two different yellow panels and two different red/pink panels. Trial plants were grown under the same conditions except using different light-reflecting panels.

FIG. 10 is a photograph showing the comparison of two groups of trial plants after 14-day growth using light-reflecting panels in this invention, started from the sprout stage at the same time. (A) Polished titanium light-reflecting panels were used to reflect light to grow plants; and (B) Anodized titanium light-reflecting panels were used to reflect light to grow plants.

### DETAILED DESCRIPTION OF THE INVENTION

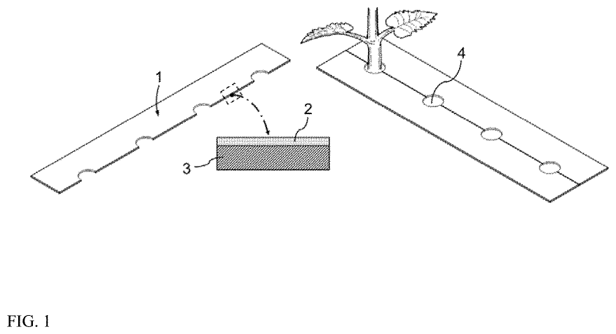

Now the preferred embodiments of the present invention are described with reference to FIGS. 1-10 of the drawings. Identical elements are designated with the same reference numerals.

The present invention can be embodied in other specific apparatus and/or methods. The described embodiments are to be considered in all respects as illustrative and not restrictive. In particular, the scope of the invention is indicated by the appended claims rather than by the descriptions and figures herein. All changes that come within the meaning and range of equivalency of the claims are to be embraced within their scope.

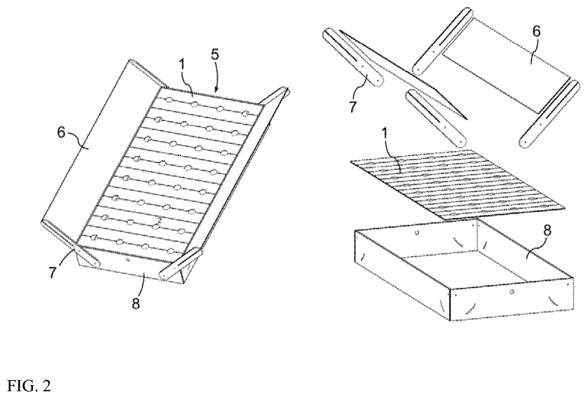

Referring now to the drawings, according to a first preferred embodiment of the present invention, FIG. 1 shows the basic constructional details of a light-reflecting panel used to reflect light from the bottom to a plant, comprising a notch 4 to allow the stem of a plant to go through. As shown in FIG. 1, the modular light-reflecting panel, denoted by reference numeral 1, comprises a coating 2 and a substrate 3. The light-reflecting panel 1 is particularly suited for reflecting controlled ranges of light wavelengths to a plant to enhance its growth. Coating 2 is mainly responsible for selecting desired ranges of light wavelengths while substrate 3 is mainly responsible for the physical and optical properties required for the application. In some aspects and embodiments said coating 2 comprises a light modifying additive which absorbs, blocks, or reflects the incident light. In some aspects and embodiments said coating 2 is at least functioning as a transparent or translucent layer. In some aspects and embodiments said coating 2 is a reflective and/or protective coating on substrate 3. In some aspects and embodiments said coating 2 comprises thin-film layers. As shown in FIG. 2, the growing media container 8 comprises slots, adapters, and mechanisms to host and control plant growing media as well as devices for supplying water/air/carbon dioxide flows to the plant. There are a wide range of materials available for making the growing media container to achieve required physical properties such as strength and weight, longevity and cost including: plastic, glass, wood, cardboard, carbon fiber, aluminum alloy and magnesium alloy.

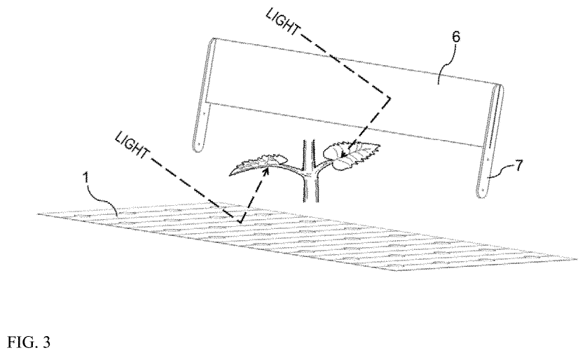

The light intensity and light quality of the reflected light used for enhancing plant growth are controlled by light reflecting efficiency and light modifying properties of the light-reflecting panel 1. In an embodiment, the plant growth apparatus comprising multiple light-reflecting panels 1 to reflect light to a plant with desired intensity and quality is modular and scalable. The size, shape, quantity, type and material of the light-reflecting panel lead to a wide range of combinations and possibilities to deliver desired light intensity and light quality for enhancing plant growth. As shown in FIG. 2, a plant growth apparatus 5 of this invention comprises 16 pieces of bottom light-reflecting panel 1, 2 pieces of side light-reflecting panel 6, panel holder 7 and growing media container 8. Such apparatus is suitable for reflecting natural sunlight or light from a fixed artificial light source to grow a plant. Paths of reflected light reaching a plant are illustrated in FIG. 3. The side light-reflecting panel 6 is mainly used to reflect the incident light to a plant from the side and the bottom light-reflecting panel 1 is used to reflect the incident light to a plant from the bottom. Reflected light reaching the upper surface of a leaf and reflected light reaching the lower surface of a leaf are both important to enhance the photosynthesis rate. The position of a light-reflecting panel can be controlled by using a panel holder 7 which comprises structural components such as slots and holes and mechanisms such as angle control for hosting said panel. Said panel holder physically connects the light-reflecting panel to the growing media container which is also used as the base of the plant growth apparatus of this invention. The panel holder allows an easy and simple control of the light-reflecting panel for adjusting the direction of the reflected light. In an embodiment, the position of the light-reflecting panel to reflect light to a plant from the side is manually controlled. In an embodiment, the position of the light-reflecting panel to reflect light to a plant from the side is automatically controlled using an automatic panel holder.

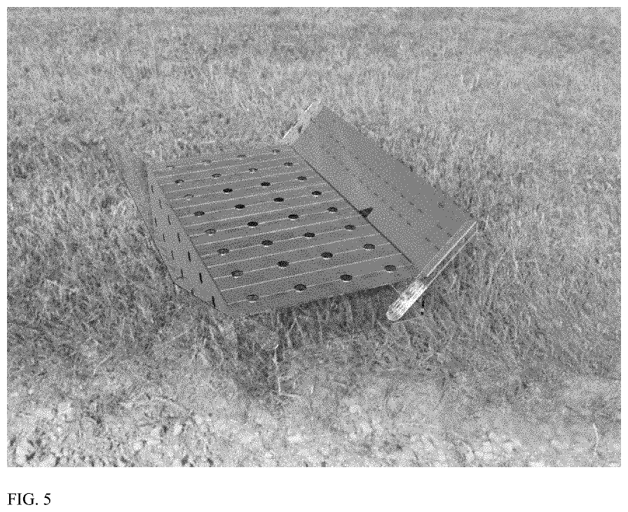

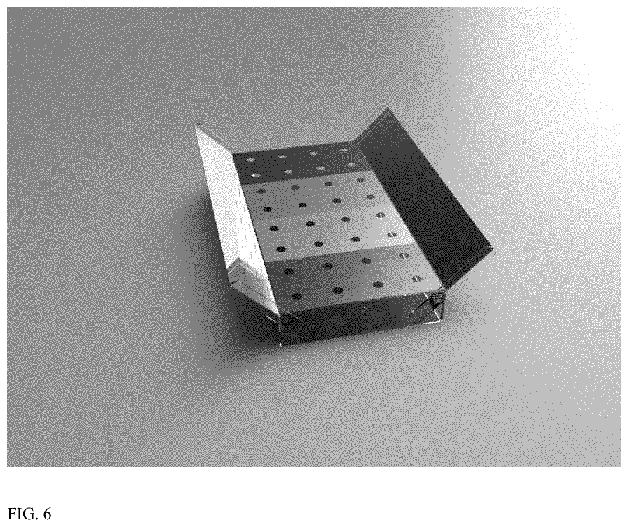

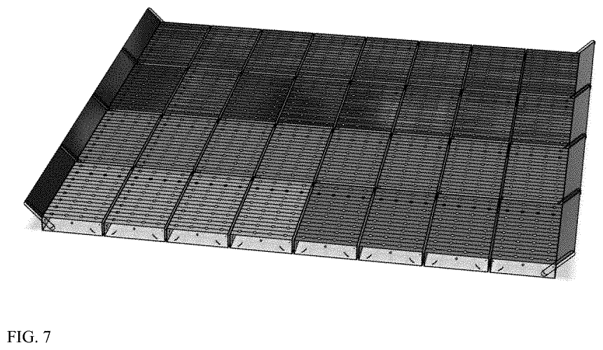

In an embodiment, a light-reflecting panel having a unique shape and structure functions independently as a device to enhance plant growth. Some aspects and embodiments are configured to enhance plant growth with the aim of using an apparatus comprising said light-reflecting panels with unique color, shape, structure, and functionalities. As shown in FIG. 5, a plant growth apparatus that can be used to grow 32 plants comprises 16 bottom pink light-reflecting panels and 2 side pink light-reflecting panels. As shown in FIG. 6, a plant growth apparatus that can be used to grow 32 plants comprises 4 bottom red light-reflecting panels, 4 bottom orange light-reflecting panels, 4 bottom yellow light-reflecting panels, 4 bottom blue light-reflecting panels and 2 side white light-reflecting panels. In an embodiment, the size of the light-reflecting panel as well as the plant growth apparatus is scalable. As shown in FIG. 7, 32 of plant growth apparatuses that can host 32 plants each are connected together to build a large plant growth apparatus that can host 1024 plants.

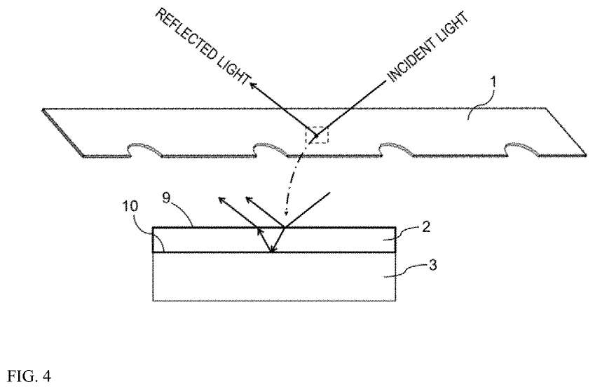

Paths of light reflected by the light-reflecting panel 1 comprising a thin layer of coating 2 and a substrate 3 are illustrated in FIG. 4. In an embodiment, the light-reflecting panel 1 works on the principle of thin-film interference in which light waves reflected by the upper boundary 9 of the thin film coating 2 interfere with light waves reflected by the lower boundary 10 of the thin film coating 2, either enhancing or reducing the overall reflected light. When white light such as sunlight or white LED light consisting of a wide range of wavelengths is incident on the thin layer coating 2, certain colors are intensified while others are attenuated. In an embodiment, said coating 2 of the light-reflecting panel 1 comprises at least one thin layer. In an embodiment, substrate 3 of the light-reflecting panel 1 is transparent or translucent. In an embodiment, a certain portion of the incident light can pass through light-reflecting panels which comprise transparent coating 2 and transparent substrate 3, to reach the growing media. In an embodiment, substrate 3 of the light-reflecting panel 1 works as a mirror which comprises at least one reflective surface. In an embodiment, the light-reflecting panel 1 is transparent or translucent. When the light-reflecting panel 1 works on the principle of thin-film interference to reflect light, it is highly reflective to certain light waves but highly transmissive to others. In an embodiment, the light-reflecting panel 1 works on the principle of thin-film interference to reflect specific wavelengths of light, comprising anodized titanium and/or anodized niobium. Main advantages of using anodized titanium and/or anodized niobium to reflect sunlight to enhance the photosynthesis rate include permanent light reflecting property that does not decrease or fade under solar radiation and the ability to change the range of reflected wavelengths simply by adjusting the reflecting angle. In an embodiment, coating 2 comprises thin layers of metals such as titanium, niobium, aluminum, sliver, molybdenum, tungsten, copper and gold. In an embodiment, coating 2 comprises thin layers of oxides such as titanium oxide, niobium oxide, silicon oxide, indium tin oxide, zinc oxide and aluminum oxide. In an embodiment, coating 2 comprises thin layers of fluorides such as MgF2, LaF3, AlF3 and CaF2. In an embodiment, coating 2 comprises thin layers of ZnS or diamond-like carbon.

In an embodiment, the light-reflecting panel 1 comprises a dielectric coated mirror, also known as the Bragg mirror, having specified reflectivity at different wavelengths of light, composing thin layers of dielectric material such as SiO2, TiO2, Al2O3, Nb2O5, Ta2O5, MgF2, LaF3, AlF3, ZnS and Parylene deposited on a substrate 3 such as BK7 glass, ceramic, fused silica, CaF2, quartz, sapphire, silicon, polymer such as acrylic, PMMA, allyl diglycol carbonate, polycarbonate, polyurethane and Mylar, or metal such as aluminum, titanium, niobium, copper, iron and steel. The light-reflecting panel 1 can deliver specified reflectivity at different wavelengths of light by using a certain type and thickness of the dielectric layers in coating 2. Main advantages of using a Bragg mirror to reflect light to enhance the photosynthesis rate include specified reflectivity at different wavelengths of light, high reflectivity over a narrow range of wavelengths and high durability of the mirror.

In an embodiment, the light-reflecting panel 1 comprises a polymer-based coating 2 such as acrylic, Mylar, PMMA, polycarbonate, Parylene, nylon, polyethylene terephthalate, polypropylene and polyethylene. In an embodiment, the light-reflecting panel 1 comprises a thin layer of reflective metal such as silver, copper, gold, aluminum, titanium, tin, chrome, molybdenum, tungsten and nickel. In an embodiment, the light-reflecting panel 1 comprises a translucent or transparent light-modifying coating that comprises light absorbing or blocking materials such as dyes, pigments, quantum dots, oxides, fluorides or minerals. In an embodiment, the light-reflecting panel 1 comprises a flat reflective surface. In an embodiment, the light-reflecting panel 1 comprises a curved reflective surface. In an embodiment, the light-reflecting panel 1 is transparent or translucent in the visible range. In an embodiment, the light-reflecting panel 1 is used to partially block the incident light. In an embodiment, the light-reflecting panel 1 comprises a metallic mirror coating comprising a thin layer of metal such as silver, aluminum, gold, titanium, copper, tin, chrome, molybdenum, tungsten, diamond-like-coating and nickel to achieve high reflectivity. In an embodiment, the light-reflecting panel 1 comprises a thin layer with thickness in the sub-nanometer to micron range.

The method of regulating and improving plant growth in this invention comprises: improving the overall light intensity received by a plant, improving the light quality by reflecting specific wavelengths of light, improving the distribution of light intensity and light quality by adjusting the reflecting angle and utilizing a combination of different light-reflecting panels, and improving the water/air/carbon dioxide flows around a plant. The growing media container 8 of the apparatus in this invention is responsible for hosting the growing media and water/air/carbon dioxide flow devices. In an embodiment, the method increases the overall light intensity received by a plant by at least 0.1%. In an embodiment, the method increases the overall light intensity received by a plant by 10-100%. In an embodiment, the method increases the overall light intensity received by a plant by greater than 100%. In an embodiment, the method increases the overall PAR light received by a plant by at least 0.1%. In an embodiment, the method increases the overall PAR light received by a plant by 10-100%. In an embodiment, the method increases the overall PAR light received by a plant by greater than 100%. In an embodiment, the method decreases the overall light intensity received by a plant. In an embodiment, the total surface area of a plant receiving the reflected light from light-reflecting panels ranges from 0.1% to 100%.

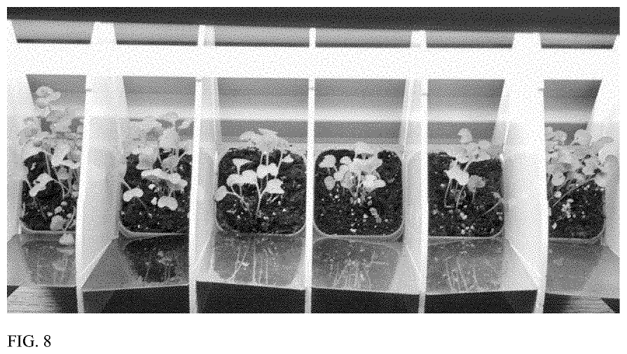

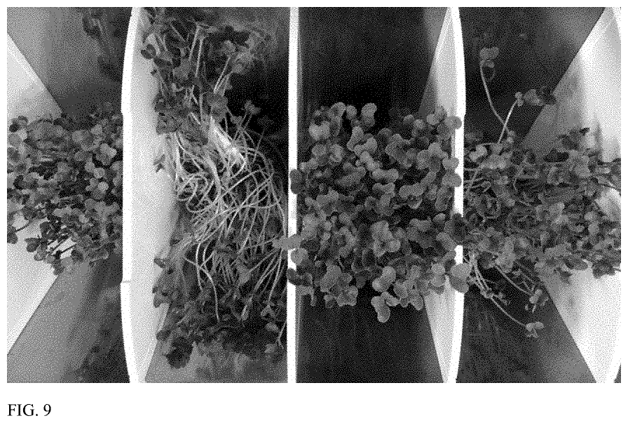

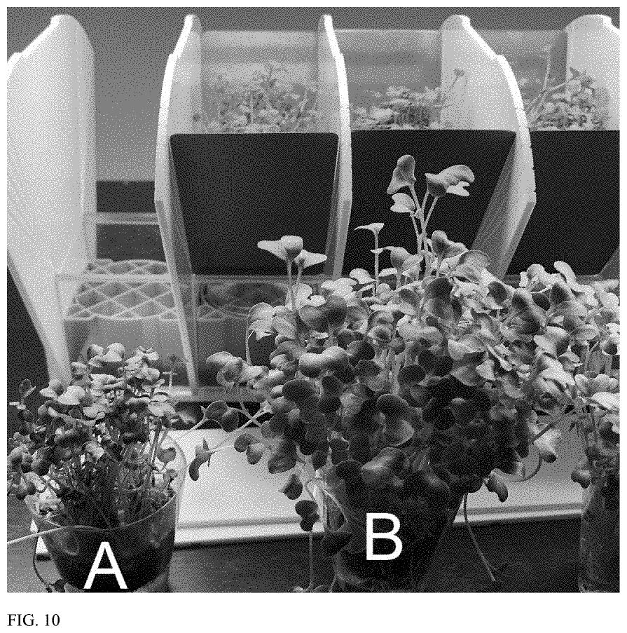

As shown in FIG. 8-9, light-reflecting panels comprising anodized titanium with a polished surface are used to reflect sunlight for plant growth. In an embodiment, sunlight reflected by certain colors of anodized titanium such as red, pink, yellow can be used to efficiently improve the growth rate of a plant. Photograph of two groups of trials plants after 14-day growth, started from the sprout stage at the same time, is shown in FIG. 10. The growing conditions for the two groups of plants are the same except the choices of light-reflecting panels. A much higher growth rate is found in group (B) where anodized titanium is used to reflect white artificial light, compared to group (A) where polished titanium is used to reflect white artificial light.

### EXAMPLES

### Example 1

Apparatus of this invention comprises light-reflecting panels comprising anodized titanium or titanium alloys. A grade 5 6Al-4V commercial titanium alloy sheet is cut, treated, and then polished to make light-reflecting panels with a flat or slightly curved reflective surface. An anodizing procedure is then applied to the polished titanium: titanium sheets are cleaned and dried and then anodized to achieve a color such as pink, orange, yellow, blue, and purple. Chemical masks can be used during a multi-stage anodizing process to achieve multiple colors on the same reflective surface. Plant growth apparatus comprising anodized titanium are durable and weatherproof.

### Example 2

Apparatus of this invention comprises light-reflecting panels comprising acrylic mirrors with colors. Commercial acrylic mirror sheets with a thickness of 1.5 mm to 4 mm are cut to make light-reflecting panels using a laser cutting machine. Commonly used colors of acrylic mirror include red, orange, pink, yellow, rose, blue, silver and purple. Modular light-reflecting panels made of acrylic mirror are then assembled together to make the plant growth apparatus. A typical 1 ft long 2 ft wide table-top sized plant growth apparatus consists of 16 pieces of 1.5″ by 12″ bottom light-reflecting panels and 2 pieces of 6″ by 24″ side light-reflecting panels.

### Example 3

Apparatus of this invention comprises a light-reflecting panel comprising a dielectric mirror or Bragg mirror. A commercial grade glass substrate is used to deposit dielectric coating layers. The substrate is treated and then cleaned. Thin layers of dielectric material are then deposited to the surface of the glass. The finished light-reflecting panel has a narrow reflection bandwidth (red light 617 nm to 698 nm) with an ultra-high PAR reflectivity of >87%. This type of transparent light-reflecting panels is typically used as the side panel for the plant growth apparatus because they partially allow sunlight to pass through.

### Example 4

Apparatus of this invention comprises a light-reflecting panel comprising a metallic reflective coating. Metal such as titanium, niobium, aluminum, sliver, molybdenum, tungsten, copper and gold is deposited on a substrate such as glass or plastic to form a mirror finished surface. The metal-coated substrate is then covered or laminated with a transparent or translucent polymer layer comprising light modifiers such as pigments, dyes, or minerals.

### Example 5

The apparatus and method of this invention is used to enhance the growth of cannabis plants. Using the plant growth apparatus, sunlight filtered by a greenhouse film is utilized as the natural light source to grow cannabis plants during the seedling stage. During the first 14 days of the seedling stage of the cannabis plant, light-reflecting panels comprising orange and pink color acrylic mirrors are used to enhance the plant growth. On a typical 1 ft long 2 ft wide plant growth apparatus comprising 16 pieces of 1.5″ by 12″ pink color bottom light-reflecting panels and 2 pieces of 6″ by 24″ orange color side light-reflecting panels, the angle between the side panels to bottom panels is set at 120 degrees from 9:00 AM to 6:00 PM every day to grow the plants, repeatedly. After the first 14 days of the seedling stage of the cannabis plant, only orange color light-reflecting panels are used to enhance the plant growth. The angle between the side panels to bottom panels is set at 130 degrees from 6:00 AM to 6:00 PM every day to grow the plants, repeatedly. The cannabis plants grown using this method reach maturity much faster than control plants using only direct sunlight and produce more tetrahydrocannabinol per weight of cannabis flower than control plants.

### Example 6

The apparatus and method of this invention is used to enhance the growth of succulent plants. Using the plant growth apparatus, unfiltered sunlight is utilized as the natural light source to grow succulent plants. Light-reflecting panels comprising purple and blue color anodized titanium are used to enhance the plant growth. On a typical 1 ft long 2 ft wide plant growth apparatus comprising 16 pieces of 1.5″ by 12″ blue color bottom light-reflecting panels and 2 pieces of 6″ by 24″ purple color side light-reflecting panels, the angle between the side panels to bottom panels is set at 100 degrees every day to grow the plants. The succulent plants grow faster and achieve richer colors using this method than control plants.

### Example 7

Apparatus and method of this invention is applied during the plant germination stage. Indoor artificial LED light above the seeds is used as the light source. Direct light is blocked to reach the seeds using an opaque plate 8 inch above the seeds. On a typical 0.5 ft long 2 ft wide plant growth apparatus comprising 24 pieces of 1″ by 6″ yellow color bottom light-reflecting panels and 2 pieces of 6″ by 24″ red color side light-reflecting panels, the angle between the side panels to bottom panels is set at 125 degrees.

### Example 8

Apparatus of this invention comprises light-reflecting panels comprising deposited and anodized titanium and/or niobium. A substrate made of an alternative material other than titanium or niobium is used. The alternative material choices include acrylic, polycarbonate, allyl diglycol carbonate or polyurethane, glass, or metal such as aluminum. A thin layer of titanium and/or niobium is then deposited on the substrate. An anodizing procedure can be applied to the titanium and/or niobium coated substrate to achieve a desired color such as pink, orange, yellow, blue, and purple. Chemical masks can be used during a multi-stage anodizing process to achieve multiple colors on the titanium and/or niobium coated surface.

We claim:

1. An apparatus for enhancing plant growth, comprising: a light-reflecting panel comprising a reflective surface capable of reflecting specific wavelengths of light to a plant; a panel holder comprising structural components and mechanisms for hosting said panels and controlling the position of said panels; and a horticulture growing media container that provides structural components and mechanisms for hosting and controlling the horticulture growing media and flows of water/fertilizer and/or air/oxygen/carbon dioxide.

2. The apparatus as claimed in claim 1, wherein said light-reflecting panel comprises a substrate and/or a coating.

3. The apparatus as claimed in claims 1-2, wherein said light-reflecting panel comprises a substrate and/or a coating with specified reflectivity and/or transmissivity at different wavelengths of light.

4. The apparatus as claimed in claims 1-3, wherein said light-reflecting panel works on the principle of a Bragg mirror or dielectric coated mirror composing deposited thin layers of dielectric materials.

5. The apparatus as claimed in claims 1-3, wherein said light-reflecting panel works on the principle of thin-film interference to reflect specific wavelengths of light.

6. The apparatus of any preceding claim, wherein said light-reflecting panel comprises a coating comprising oxides such as TiO2, Al2O3, Nb2O5, SiO2, ITO, ZnO and Ta2O5, fluorides such as MgF2, LaF3, CaF2 and AlF3, nitrides such as TiN, NbN and TiNbN, metal such as titanium, niobium, aluminum, anodized titanium, anodized niobium, anodized aluminum, molybdenum, tungsten, germanium, silver, nickel, chromium, chrome, nichrome, tin, copper, gold and iron, polymers such as Parylene, acrylic, Mylar, PMMA, polycarbonate, allyl diglycol carbonate, polyurethane, nylon, polyethylene terephthalate, polypropylene and polyethylene, and diamond-like carbon, glass, quartz, sapphire, ZnS and silicon.

7. The apparatus of any preceding claim, wherein said light-reflecting panel comprises a substrate comprising glass, BK7 glass, ceramic, fused silica, CaF2, quartz, sapphire, silicon, polymer such as Parylene, acrylic, Mylar, PMMA, polycarbonate, allyl diglycol carbonate, polyurethane, nylon, polyethylene terephthalate, polypropylene and polyethylene, or metal such as aluminum, titanium, niobium, copper, iron and steel.

8. The apparatus of any preceding claim, wherein said light-reflecting panel comprises a translucent or transparent coating and/or substrate.

9. The apparatus of any preceding claim, wherein said coating and/or said substrate further comprise light absorbing and/or blocking and/or diffusing materials such as dyes, pigments, quantum dots, or minerals.

10. The apparatus of any preceding claim, wherein said light-reflecting panel has a flat and/or curved shape and comprises a reflective surface with a reflectivity from 0.1% to 100%.

11. The apparatus of any preceding claim, wherein said light-reflecting panel is capable of reflecting solar radiation and/or artificial light in the photosynthetically active radiation (PAR) spectral region from 400 nm to 700 nm.

12. The apparatus of any preceding claim, wherein said light-reflecting panel is capable of reflecting solar radiation and/or artificial light in the ultraviolet spectral region from 10 nm to 400 nm.

13. The apparatus of any preceding claim, wherein said light-reflecting panel is capable of reflecting solar radiation and/or artificial light in the far red spectral region from 700 nm to 850 nm.

14. The apparatus of any preceding claim, wherein said panel holder can adjust the angle of light reflected by the light-reflecting panel from 0-180 degrees.

15. A method for regulating and improving plant growth, comprising the steps of: changing the overall light intensity received by a plant by reflecting natural sunlight or artificial light to the plant; changing the light quality received by a plant by reflecting specific wavelengths of light to a plant; Improving the distribution of light intensity and light quality by controlling the angle of reflected light; Improving the distribution of light intensity and light quality by utilizing a combination of modular light-reflecting panels.

16. The method according to claim 15, characterized in that said overall light intensity received by a plant increases from 0% to 100%.

17. The method according to claim 15, characterized in that said overall light intensity received by a plant increases greater than 100%.

18. The method according to claim 15-17, wherein said light quality is changed by reflecting light with a wavelength in the range from 10 nm to 850 nm to a plant.

19. The method of regulating and improving plant growth as claimed in claim 15-18, wherein said angle of reflected light ranges from 0 degrees to 180 degrees.

20. The method of regulating and improving plant growth as claimed in claim 15-19, wherein the percentage of surface area of a plant receiving said reflected light ranges from 0.1 to 100.
